(19) United States
(12) Patent Application Publication
(10) Pub. No.: US 2024/0208358 A1
(43) Pub. Date: Jun. 27, 2024

(54) METHOD AND DEVICE FOR MANAGING A BATTERY OF A MOVING OBJECT

(71) Applicants: HYUNDAI MOTOR COMPANY, Seoul (KR); KIA CORPORATION, Seoul (KR)

(72) Inventor: Young Kwang Kim, Ansan-si (KR)

(21) Appl. No.: 18/507,366

(22) Filed: Nov. 13, 2023

(30) Foreign Application Priority Data
Dec. 22, 2022 (KR) 10-2022-0181578

(51) Int. Cl. B60L 58/12; B60L 58/40

(52) U.S. Cl. CPC B60L 58/12; B60L 58/40

(57) ABSTRACT

A method for managing a battery of a moving object includes generating, prediction profile information for predicting a future temperature at a position of the moving object, based on surrounding station information and current position information of the moving object, determining a lowest estimated temperature based on an observed outdoor temperature at a shutdown request, a predicted shutdown temperature at the shutdown request, and a lowest predicted temperature of the prediction profile information, and charging a first battery by using a second battery so that a required output power for start-up is secured in response to a predicted available output power of the first battery being equal to or smaller than the required output power for start-up.

### CROSS REFERENCE TO RELATED APPLICATIONS

The present application claims priority to a Korean patent application 10-2022-0181578, filed Dec. 22, 2022, the entire contents of which are incorporated herein for all purposes by this reference.

### BACKGROUND

### Field

The present disclosure relates to a method and device for managing a battery of a moving object and, more particularly, to a method and device for managing a battery of a moving object to realize normal startup at a low temperature.

### Description of the Related Art

Generally, in a pure electric vehicle using a battery as an energy source and a fuel cell-based electric vehicle using a fuel cell connected to a battery as an energy source, batteries are a crucial factor for the quality of the moving objects. A battery of a fuel cell-based vehicle may be charged by power generation of the fuel cell.

Accordingly, a battery management system (BMS), which manages an overall state of a battery, may prevent the early reduction of battery life and support power generation control and driving control by notifying information on a amount of charge (or state of charge (SOC)) of the battery to a vehicle control means that performs integrated control.

The main functions of a BMS include predicting a SOC, detecting full charge of a battery, maintaining voltage balance between each cell module, controlling a maximum charge and discharge voltage according to an SOC of a battery, and performing safety management and cooling management, and a conventional method of calculating an SOC of a battery is used for calculating a current SOC by measuring charge and discharge currents.

In an electric moving object using a fuel cell, an internal resistance of a battery, more specifically, a high-voltage battery increases as the temperature decreases, and an output power of the battery may also change depending on the amount of charge, even at the same amount of charge. A maximum output power of a battery may be reduced in a cold condition. A phenomenon in which the voltage drops rapidly occurs in a task that requires a lot of power from a high-voltage battery, such as starting up a moving object.

Such a voltage drop of a high-voltage battery may interrupt normal operation of a power conversion device that transforms a power type between a fuel cell and the high-voltage battery. For example, a power conversion device may be a step-up/step-down transformer. The abnormal operation of a power conversion device may interrupt a normal energy flow between a fuel cell and a high-voltage battery during a startup process. In a worst case, energy cutoff or reversed energy flow may occur.

Accordingly, in case a plurality of batteries like a high-voltage battery and a fuel cell and a power conversion device are used, even when the startup of a vehicle is requested, if there is a sudden temperature drop while the vehicle is parked and is not used, an unexpected situation may occur in which startup is not normally operated.

Energy cutoff or abnormal energy flow between batteries during startup may have a bad effect on the durability of a battery and a power conversion device. Besides, as another problem, it costs a lot to exchange and repair expensive components. In addition, even when a voltage condition of batteries is within a normal operation range, an increase of internal resistance at a low temperature may disable a fuel cell from providing an instantaneous power amount required for normal startup of a high-voltage battery. Thus, normal startup may become impossible. When a user keeps attempting startup in a situation where normal startup is impossible, a high-voltage battery completely discharges and thus a failure situation may occur in which normal operation is impossible even after an outdoor temperature rises. Accordingly, repair works for failure such as replacing or charging a high-voltage battery are required, and this results in an unnecessary cost and a user's inconvenience.

### SUMMARY

The present disclosure is directed to provide a method and device for managing a battery of a moving object, which may realize normal startup at a low temperature.

In detail, the present disclosure is directed to predict future temperature conditions and battery conditions before the start-up ends and replenish the battery in order to ensure normal start-up under low-temperature.

The technical objects of the present disclosure are not limited to the above-mentioned technical objects, and other technical objects that are not mentioned will be clearly understood by those skilled in the art through the following descriptions.

According to the present disclosure, there is provided a method for managing a battery of a moving object, the method comprising generating, in response to a shutdown request of the moving object, prediction profile information for predicting a future temperature at a position of the moving object, based on surrounding station information, which is based on a position of a weather station near the moving object and climate information, and current position information of the moving object, determining a lowest estimated temperature at the position of the moving object based on an observed outdoor temperature at a time of the shutdown request, a predicted shutdown temperature at the time of the shutdown request, the predicted shutdown being based on the prediction profile information, and a lowest predicted temperature of the prediction profile information; and charging a first battery by using a second battery so that a required output power for start-up is secured in response to a predicted available output power of the first battery, which is based on the lowest estimated temperature and an amount of charge of the first battery of the moving object, being equal to or smaller than the required output power for start-up.

According to the embodiment of the present disclosure in the method, the surrounding station information may include a surrounding latitude, a surrounding longitude according to the position and ambient temperature profile information based on the climate information, and the ambient temperature profile information may include lowest ambient temperature profile information, which is generated based on a lowest annual daily temperature, and highest ambient temperature profile information that is generated based on a highest annual daily temperature.

According to the embodiment of the present disclosure in the method, the lowest ambient temperature profile information may be generated as a lower bound approximation curve by applying numerical optimization using the lowest annual daily temperature, and the highest ambient temperature profile information may be generated as a lower bound approximation curve by applying numerical optimization using the highest annual daily temperature. Also, the lowest ambient temperature profile information and the highest ambient temperature profile information further may include a function coefficient parameter corresponding to an order defining constant, which is required in each numerical optimization, and the function coefficient parameter is stored in the moving object.

According to the embodiment of the present disclosure in the method, the surrounding station information may be obtained in plurality from a plurality of weather stations that are located in an order of proximity from the position of the moving object. The prediction profile information may include the lowest predicted temperature and a highest predicted temperature, which are generated based on the plurality of the surrounding station information and the position information of the moving object. Also, the prediction profile information may be generated according to each time section of a single day based on the lowest predicted temperature and the highest predicted temperature.

According to the embodiment of the present disclosure in the method, the lowest predicted temperature and the highest predicted temperature may be generated by applying temperature correction according to altitude information of the moving object, which is included in the position information.

According to the embodiment of the present disclosure in the method, the prediction profile information may include daytime prediction profile information and nighttime prediction profile information according to each time section of the single day. The daytime prediction profile information may be generated based on daylight hours estimated at the position of the moving object, the highest predicted temperature and the lowest predicted temperature. Also, the nighttime prediction profile information may be generated based on night hours estimated at the position of the moving object, the lowest predicted temperature, and a sunset temperature that is predicted through the daytime prediction profile information.

According to the embodiment of the present disclosure in the method, the predicted shutdown temperature may be determined by using prediction profile information belonging to the shutdown time among the daytime prediction profile information and the nighttime prediction profile information.

According to the embodiment of the present disclosure in the method, the method may further comprise determining a lowest estimated temperature at the position of the moving based on the predicted shutdown temperature and the lowest predicted temperature of the prediction profile information, when the observed outdoor temperature is not obtained.

According to the embodiment of the present disclosure in the method, the determining of the lowest estimated temperature may comprise determining the lowest predicted temperature as the lowest estimated temperature, when the observed outdoor temperature is equal to or higher than the predicted shutdown temperature, and determining the lowest predicted temperature as the lowest estimated temperature compensated for deviation though the observed outdoor temperature and the predicted shutdown temperature, when the observed outdoor temperature is lower than the predicted shutdown temperature.

According to the embodiment of the present disclosure in the method, the second battery may be configured as a fuel cell that is a different type from the first battery.

According to another embodiment of the present disclosure, there is provided a device for managing a battery of a moving object, the device comprising a memory configured to store at least one instruction, and a processor configured to execute the at least one instruction stored in the memory. The processor is configured to: generate, in response to a shutdown request of the moving object, prediction profile information for predicting a future temperature at a position of the moving object, based on surrounding station information, which is based on a position of a weather station near the moving object and climate information, and current position information of the moving object, determine a lowest estimated temperature at the position of the moving object based on an observed outdoor temperature at a time of the shutdown request, a predicted shutdown temperature at the time of the shutdown request, the predicted shutdown being based on the prediction profile information, and a lowest predicted temperature of the prediction profile information; and charge a first battery by using a second battery so that a required output power for start-up is secured in response to a predicted available output power of the first battery, which is based on the lowest estimated temperature and an amount of charge of the first battery of the moving object, being equal to or smaller than the required output power for start-up.

The features briefly summarized above for this disclosure are only exemplary aspects of the detailed description of the disclosure which follow, and are not intended to limit the scope of the disclosure.

According to the present disclosure, it is possible to provide a method and device for managing a battery of a moving object to realize normal startup at a low temperature.

Effects obtained in the present disclosure are not limited to the above-mentioned effects, and other effects not mentioned above may be clearly understood by those skilled in the art from the following description.

The technical problems solved by the present disclosure are not limited to the above technical problems and other technical problems which are not described herein will be clearly understood by a person (hereinafter referred to as an ordinary technician) having ordinary skill in the technical field, to which the present disclosure belongs, from the following description.

### BRIEF DESCRIPTION OF THE FIGURES

FIG. 1 is a block diagram showing constituent modules of a moving object with a battery management device according to an embodiment of the present disclosure.

FIG. 2A and FIG. 2B are flowcharts associated with a method for managing a battery of a moving object according to another embodiment of the present disclosure.

FIG. 3 is a view exemplifying a process of determining a plurality of weather stations around a moving object.

FIG. 4 is a view exemplifying a table of surrounding station data managed by a plurality of weather stations.

FIG. 5 is a flowchart associated with a process of generating ambient temperature profile information.

FIGS. 6A and 6B are views exemplifying lower bound approximation curves of highest ambient temperature profile information and lowest ambient temperature profile information respectively.

FIG. 7 is a view exemplifying line plots of prediction profile information that predicts temperatures at a position of a moving object.

FIG. 8 is a view exemplifying a table that shows an available output of a battery according to temperatures and SOC of the battery.

### DETAILED DESCRIPTION

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present invention and the way of attaining them will become apparent with reference to embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the invention to those skilled in the art.

In the present disclosure, each of phrases such as “A or B”, “at least one of A and B”, “at least one of A or B”, “A, B or C”, “at least one of A, B and C”, “at Each of the phrases such as “at least one of A, B or C” and “at least one of A, B, C or combination thereof” may include any one or all possible combinations of the items listed together in the corresponding one of the phrases

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

Hereinafter, embodiments of the present disclosure will be described with reference to the accompanying drawings.

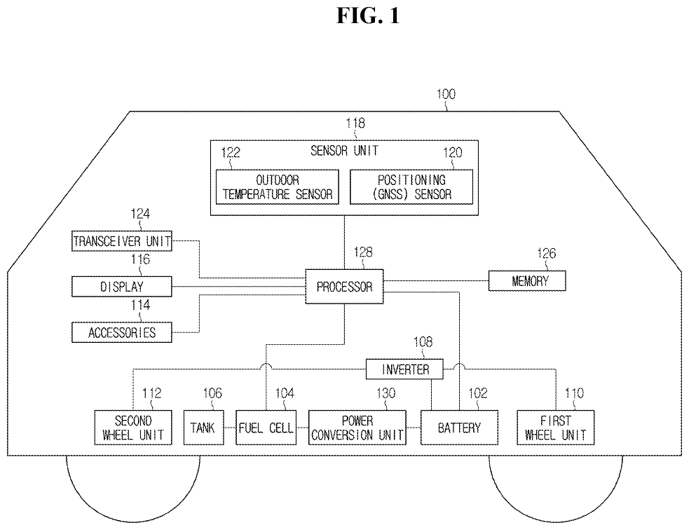

Hereinafter, referring to FIG. 1, a battery management device of a moving object will be described in accordance with an embodiment of the present disclosure.

FIG. 1 is a block diagram showing constituent modules of a moving object with a battery management device according to an embodiment of the present disclosure.

A moving object 100 may be driven based on electrical energy. Specifically, the moving object 100 may employ an electric battery capable of being directly charged or a gas-based fuel cell as an energy source. As for a fuel cell, the moving object 100 may use various types of gas capable of generating electric energy in the fuel cell, and the gas may be hydrogen, for example. However, the gas is not limited thereto, and various types of gas may be applied. In the present disclosure, among moving objects using electrical energy, the fuel cell-based moving object 100 will be described as an example. However, the present disclosure is applicable to any moving object that has heterogeneous types of first and second batteries and employs a method of charging the first battery, which outputs power for startup and driving of the moving object, by generating the second battery.

For example, the moving object 100 may refer to a device capable of moving. As a vehicle running on the ground, the moving object 100 may be a normal passenger or commercial moving object, a mobile office, or a mobile hotel. The moving object 100 may be a four-wheel moving object such as a sedan, a sports utility vehicle (SUV), and a pickup truck and may also be a moving object with five or more wheels such as a lorry, a container moving object, and a heavy moving object. The moving object 100 may be a manned or unmanned robot using a plurality of batteries such as a robotic device for a construction machine.

In addition, the moving object 100 is not limited to a ground moving object but may be an aerial moving object using a plurality of batteries or a water moving object for water transportation. An aerial moving object includes a manned or unmanned aerial object, and an unmanned aerial object may be a drone or a personal aerial vehicle (PAV). A water moving object may be a manned or unmanned ship or submarine.

Furthermore, the moving object 100 is not limited to transportation on Earth but may be a moving object operating in outer space beyond Earth such as a rover using a plurality of batteries on the surface of the moon and a spacecraft using a plurality of batteries.

The moving object 100 may be implemented by manual driving or autonomous driving (either semi-autonomous or full-autonomous driving).

Meanwhile, the moving object 100 may communicate with another device or another moving object. Herein, as an example, the moving object may communicate with another device based on cellular communication, WAVE communication, dedicated short range communication (DSRC), or other communication schemes. That is, as a cellular communication network, a communication network such as LTE, 5G, WiFi communication network, WAVE communication network, etc. may be used. In addition, a local area network used in a moving object, such as DSRC may be used, and the present disclosure is not limited to the above-described embodiment.

Hereinafter, for convenience of description, the embodiments according to the present disclosure will be described with the moving object 100 being exemplified as a vehicle operating on the ground. However, the embodiments of the present disclosure may be applied to the above-described various types of moving objects, that is, an aerial moving object, a water moving object, and a moving object for outer space.

Specifically, in the case of a vehicle exemplified in FIG. 1, the moving object 100 may include a battery 102, a fuel cell 104, a first wheel unit 110, a second wheel unit 112, accessories 114, a display 116, a sensor unit 118, a transceiver unit 124, a memory 126, a processor 128, and a power conversion unit 130.

Being charged by power generation of the fuel cell 104, the battery 102 may supply necessary power to a module of the moving object 100 and be a type of a first battery according to the present disclosure. For example, the battery 102 may supply power required for startup of the moving object 100 and provide energy for driving of the moving object 100 and operation of the accessories 114. Specifically, the battery 102 may provide energy, which is applied from the fuel cell 104, to the startup, driving, lighting, air-conditioning and many other electrical devices of the moving object 100. The battery 102 may output a higher voltage than the fuel cell 104 and provide energy to, by way of example, a driving wheel and a high-power electrical module.

The fuel cell 104 may be a type of a second battery according to the present disclosure. The fuel cell 104 may include a hydrogen fuel cell with a plurality of stacks that generate electrical energy through reaction between hydrogen supplied from the tank 106 and oxygen from outside. In addition, the fuel cell 104 may not only charge the battery 102 but also provide energy to a low-power electrical module.

The power conversion unit 130 may be a converter that functions as a step-up/step-down transformer. In the present disclosure, the power conversion unit 130 may be a term referring to a power conversion device. The power conversion unit 130 may charge the battery 102 by converting a voltage from the fuel cell 104 and providing it to the battery 102. Depending on an operating condition, the power conversion unit 130 may supply power to a motor of the first and second wheel units 110 and 112, which operates in a high-voltage range, and various electronic devices (e.g., the accessories 114) at a converted voltage.

The moving object 100 may include an inverter 130, which converts a particular type of power of the battery 102 into another type and reduces voltage, and at least one of the first and second wheel units 110 and 112 configured to drive by receiving power from the inverter 130. The first and second wheel units 110 and 112 may be configured to have a power transmission system other than wheels and motors. In case at least one of the first and second wheels 110 and 112 is a driving wheel, there may be a motor, which transfers a driving force to a wheel, and a motor control module configured to control a motor torque, a motor rotation direction, and braking. A motor in a wheel unit may be driven by receiving power that is applied from the battery 102 and passes through the inverter 108. The inverter 108 may convert a specific form of power, for example, an alternating current to another form, that is, a direct current and reduce a voltage.

The accessories 114 are auxiliary devices mounted in the moving object 100 and may be, by way example, a startup system, a driving transmission system, a lighting system, an air-conditioning system, and various devices installed in the moving object 100.

The display 116 may function as a user interface. The display 116 may display, by means of the processor 128, the operation state, control state, route/traffic information, battery state, remaining gas information of the moving object 100 and contents requested by a user. The display 116 may be configured by a touch screen capable of detecting a user input so that it may receive a user's request that gives a command to the processor 128.

The sensor unit 118 may have various types of sensor modules for detecting various states and situations that occur inside a moving object and in an external environment. For example, the sensor 118 may include a positioning sensor 120 for measuring a position of the moving object 100 and an outdoor temperature sensor 122 for measuring an outdoor temperature at a current position of the moving object 100. Although not illustrated, the sensor unit 118 may include an image sensor, which provides a visual image an interior or exterior of the moving object 100, a LiDar, a radar sensor, a distance sensor, an acceleration sensor, a wheel speed sensor, and a gyro sensor for detecting the posture and orientation of the moving object 100. The present disclosure mainly describes sensors, which are referred to in describing an embodiment, but may further include a sensor for detecting various situations not listed herein.

The positioning sensor 120 may measure two-dimensional positions and altitudes of the moving object 100 that is being parked or driven. For example, the positioning sensor 120 may be a GPS sensor, and the GPS sensor may measure a position of the moving object 100 based on information transmitted from a plurality of satellites. The positioning sensor 120 is not limited to a GPS sensor and may be configured as a plurality of sensors combined with other sensors including the GPS sensor. Specifically, the positioning sensor 120 may use at least one GNSS system and combine a GPS and such satellites as Galileo and QZSS.

The transceiver unit 124 may support mutual communication with a moving object around the moving object 100, a traffic intelligence service server or a road side unit, a server providing various moving object services, or an edge device. The moving object 100 may obtain surrounding station information from a weather station around the moving object 100 through the transceiver 124. For example, surrounding station information may include not only a surrounding latitude and a surrounding altitude according to a position of a weather station but also ambient temperature profile information based on climate information.

The memory 126 may store an application for controlling the moving object 100 and various data, load the application at a request of the processor 128, or read and record data. In the present disclosure, the memory 126 may store an application and at least instruction for predicting a lowest estimated temperature at a shutdown request of the moving object 100 and for charging the battery 102 by determining a required output power for start-up so that a predicted available output power of the battery 102 can generate the required output power for start-up even at the lowest estimated temperature. As an example, the required output value may be a minimum output value that is necessary for startup of the moving object 100. In addition, the memory 126 may store various information obtained through the transceiver unit 124, for example, surrounding station information and information that is generated or managed to determine a lowest estimated temperature.

The processor 128 may perform overall control of the moving object 100. The processor 128 may be configured to execute an application and an instruction stored in the memory 126. The processor 128 may have at least one processing module, and each control-related function may be implemented in a single processing module or in a corresponding processing module among a plurality of modules. According to the present disclosure, the processor 128 may determine a lowest estimated temperature and a target amount of charge by using an application, an instruction and data stored in the memory 126 and control the moving object 100 to charge the battery 102 through the fuel cell 104.

Specifically, in response to detection of a shutdown request of the moving object, the processor 128 may generate prediction profile information for predicting a further temperature at the position of the moving object, based on surrounding station information, which is based on a position of a weather station and climate information, and current position information of the moving object. The processor 128 may determine a lowest estimated temperature at a moving object position, based on an observed outdoor temperature at a time of shutdown request, a shutdown prediction temperature at a time of shutdown request based on prediction profile information and a lowest predicted temperature of prediction profile information. In addition, in case the predicted available output power of the battery 102, which is based on a lowest estimated temperature and an amount of charge of the battery 102 mounted in the moving object 100, is equal to or lower than the required output power for start-up, the processor 128 may control the moving object 100 to charge the battery 102 by using the fuel cell 104 in order to the required output power.

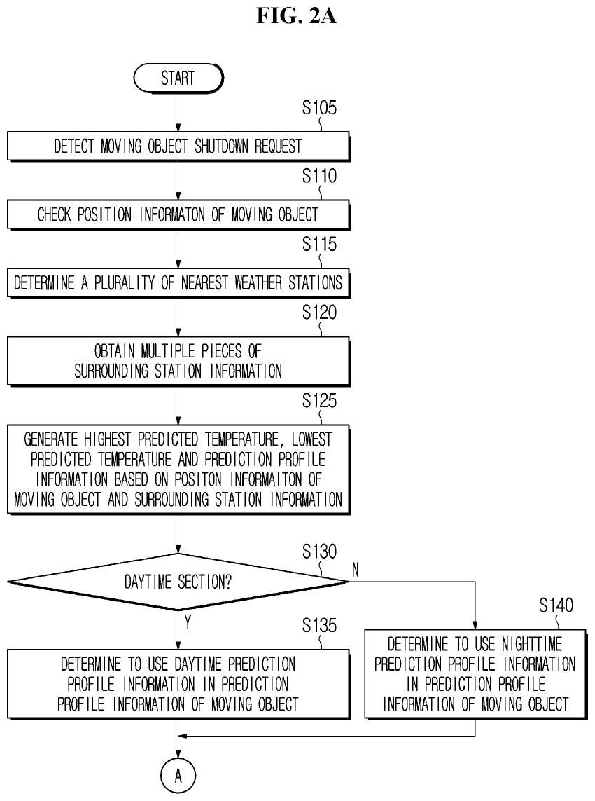

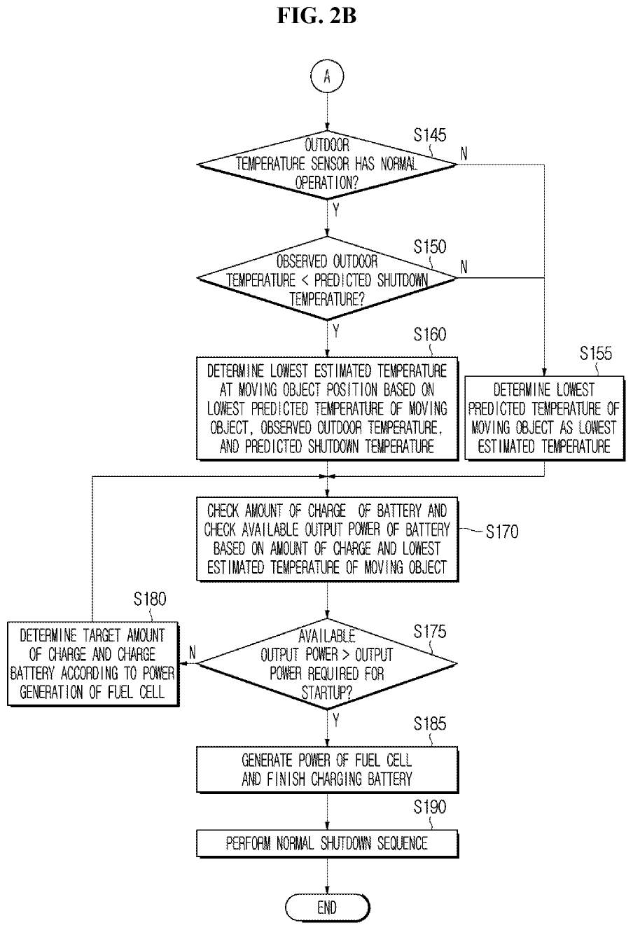

Including at least the sensor 118, the memory 126 and the processor 128, a battery management device according to the present disclosure may be a device configured to implement, by the processor 128, processing of charging the battery 102 by using the fuel cell 104 so that the battery 102 can generate a required output power necessary for startup even at a lowest estimated temperature. The processing may be performed in at least a part of the processor 128, that is, at least one processing module and in at least a part of the memory 126. As another example, an individual processor and an individual memory, which are mounted in a vehicle control unit (VCU), a battery management system (BMS) of the battery 102 and a fuel cell system (FCU) respectively, may perform the processing. An individual processor and an individual memory may constitute the processor 128 and the memory 126 according to the present disclosure. The above-described processing of the processor 128 will be described in detail through FIG. 2A to FIG. 9.

A method for managing a battery of a moving object will be described in detail with reference to FIG. 2A and FIG. 2B. FIG. 2A and FIG. 2B are flowcharts associated with a method for managing a battery of a moving object according to another embodiment of the present disclosure.

First, the processor 128 may detect a shutdown request of the moving object 100 through a user's manipulation at S105.

For example, the shutdown request may be recognized through a user's manipulation for ignition off, which turns off the ignition of the moving object 100 alone, and full turn-off that turns off both the ignition and the overall power supply of the moving object 100.

Next, the processor 128 may check current position information of the moving object 100 and time information of shutdown at S110.

For example, the position information of the moving object 100 may be measured by using the positioning sensor 120. The positioning sensor 120 may include the latitude, longitude and altitude of the moving object 100. In addition, for example, time information may be date and time recorded in the positioning sensor 120 that measures a current position of the moving object 100. Specifically, the positioning sensor 120 may generate position information and time information at a time of measuring a position, and the processor 128 may obtain the position information and the time information from the positioning sensor 120. As another example, regardless of position information, time information may be obtained from a separate module, that is, the processor 128 and the transceiver unit 124 of the moving object 100. The processor 128 may generate a system time of the entire moving object, and an acquisition time of time information and position information may be recorded by being synchronized with the system time. The transceiver unit 124 may receive time information from outside, and an acquisition time of position information may be recorded by being synchronized with a time of being received through the transceiver unit 124.

Next, the processor 128 may identify a position of a surrounding weather station around the moving object 100 through the transceiver unit 128 and determine a predetermined number of weather stations located in an order of proximity from a position of the moving object in order to obtain surrounding station information at S115.

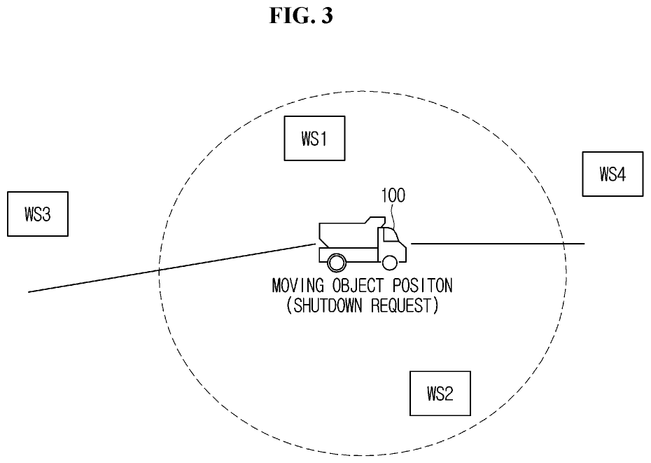

FIG. 3 is a view exemplifying a process of determining a plurality of weather stations around a moving object.

First, a weather station considered in a determining process may be a station located in a region with a lowest mean temperature by latitude at a time interval including date and time of requesting moving object shutdown or in a period including cold weather. Specifically, when a plurality of weather stations is located in a same latitude section, a weather station showing a lowest mean temperature during the period may be designated as a station representing the latitude. According to a predetermined criterion, there may be at least one station thus designated.

By assuming that the moving object 100 is a vehicle, the present disclosure illustrates that a weather station is an observatory fixed at a specific point. However, for example, in case the moving object 100 is an aerial moving object or a water moving object, a weather station may be a weather observatory fixed near the moving object 100, or a simple observatory or a mobile observatory capable of collecting data for weather observation. For example, a mobile observatory may be a moving object moving within a predetermined range of distance from a specific latitude and collect data for weather observation within the range.

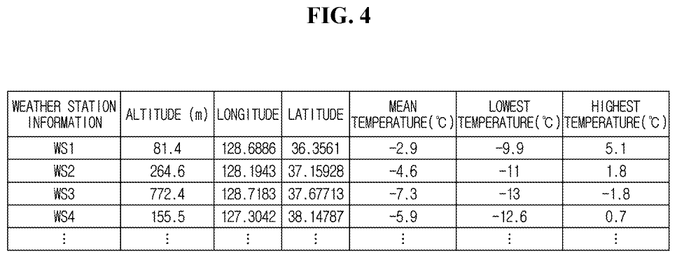

FIG. 4 is a view exemplifying a table of surrounding station data managed by a plurality of weather stations. A control server, which performs overall management of a plurality of weather stations, may collect surrounding station data exemplified in FIG. 4 from each station and designate a weather station represented according to each latitude based on the surrounding station data. For example, the surrounding station data may include position information of stations WS1 and WS2 and a mean temperature, a lowest temperature and a highest temperature during the period. Position information may include a latitude, a longitude, and an altitude of the stations WS1 and WS2. The stations WS1 to WS4 exemplified in FIG. 4 may be representative stations of each latitude among a plurality of weather stations around a moving object. A control server may control designated weather stations WS1 to WS4 to transmit surrounding station information requested by the moving object 100.

Next, for example, when a shutdown request of the moving object 100 occurs, the moving object 100 may identify a position of each station by communicating with a plurality of surrounding weather stations WS1 to WS4 and determine 2 weather stations WS1 and WS2 in an order of proximity from the moving object position.

Referring again to FIG. 2A, the processor 128 may request and obtain surrounding station information from a plurality of determined weather stations WS1 and WS2 at S120.

The surrounding station information may be information that is transmitted to the determined weather stations WS1 and WS2 respectively. For example, the surrounding station information may include surrounding position information according to positions of respective stations WS1 and WS2 and ambient temperature profile information based on climate information of respective stations WS1 and WS2. Surrounding position information may have surrounding latitudes, surrounding longitudes and surrounding altitudes of respective stations WS1 and WS2. Ambient temperature profile information may include lowest ambient temperature profile information and highest ambient temperature profile information.

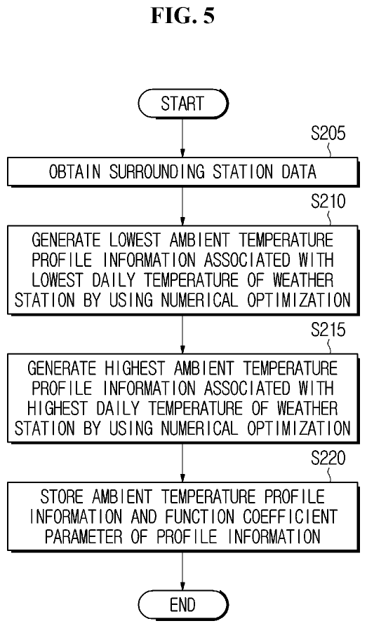

Referring to FIG. 5, a process of generating ambient temperature profile information by each of the stations WS1 and WS2 will be described. FIG. 5 is a flowchart associated with a process of generating ambient temperature profile information.

First, each of the stations WS1 and WS2 may obtain surrounding position information and climate information of the stations WS1 and WS2 at S205.

As described above, surrounding position information may be information associated with latitudes, longitudes and altitudes of the stations WS1 and WS2.

For example, climate information may be data based on temperatures, which the stations WS1 and WS2 keep measuring on a daily basis, that is, a lowest annual daily temperature and a highest annual daily temperature.

Next, by using numerical optimization, lowest ambient temperature profile information associated with lowest daily temperatures of the weather stations WS1 and WS2 may be generated at S210. In addition, by using numerical optimization, highest ambient temperature profile information associated with highest daily temperatures of the weather stations WS1 and WS2 may be generated at S215.

Temperature profile information associated with steps S210 and S215 may be calculated by applying numerical optimization that uses a lowest annual daily temperature and a highest annual daily temperature according to Equation 1 and Equation 2. Tₘᵢₙ^{day} may be a lowest temperature of a day with a lowest annual daily temperature among lowest annual daily temperatures, and Tₘₐₓ^{day} may be a highest temperature of a day with a highest annual daily temperature among highest annual daily temperatures.

$${\vec{T}}_{min} = {[ \begin{matrix}{T}_{min}^{1} & … & {T}_{min}^{365}\end{matrix} ]}^{T} \qquad Equation 1$$

$${\vec{T}}_{max} = {[ \begin{matrix}{T}_{max}^{1} & … & {T}_{max}^{365}\end{matrix} ]}^{T} \qquad Equation 2$$

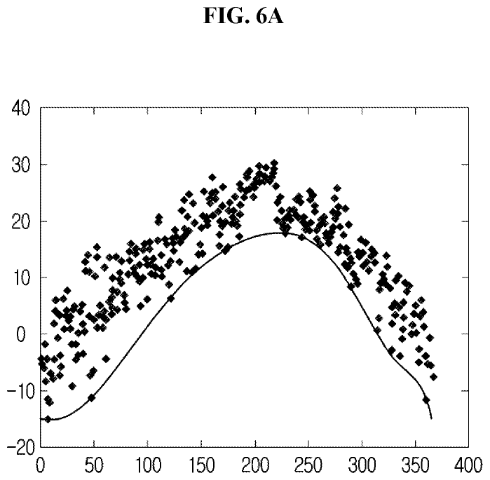

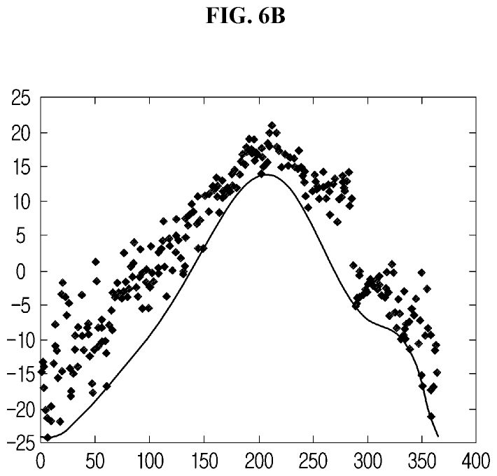

Specifically, the lowest ambient temperature profile information may be generated as a lower bound approximate curve, as exemplified in FIG. 6A, by applying numerical optimization using a lowest annual daily temperature. The highest ambient temperature profile information may be generated as a lower bound approximate curve, as exemplified in FIG. 6B, by applying numerical optimization using a highest annual daily temperature.

A lower bound approximate curve may be expressed by Equation 3 and be calculated by finding numerical optimization using Equation 4 and Equation 5 as an example. Numerical optimization may be performed to maximize the lower area of a curve exemplified in FIG. 6. fⁿ(d) is a function expressing ambient temperature profile information of each of the stations WS1 and WS2 according to a date of a year and may be called, for example, a coldest day scenario of a station.

$${f}^{n} ( d ) = {\sum }_{i = 0}^{n - 1} {{c}_{i} ( \frac{d}{365} )}^{i} \qquad Equation 3$$

Here, cᵢ may be a polynomial coefficient, d may represent a day of year, and n may be a order-defining constant (20 in this example). In the present disclosure, n is exemplified as 20. In case n is 20, a lower bound approximate curve, which represents lowest ambient temperature profile information, may be calculated by using only 20 constants. In addition, a lower bound approximate curve, which represents highest ambient temperature profile information, may be calculated by using only 20 constants. Accordingly, the above-described temperature profile information may be generated by using a small amount of data.

$${f}_{x}^{n *} = {max}_{\begin{matrix}{g}_{e} = 0 , \\ {\vec{g}}_{i} \leq \vec{0}\end{matrix}} , {\int }_{1}^{365} {f}_{x}^{n} ( z ) dz \qquad Equation 4$$

Here, x represents whether or not a lowest/highest daily temperature (min or max), \vec{g}ᵢ is Equation 5, gₑ=fⁿ(1)−fⁿ(365) and if gₑ=fⁿ(1)−fⁿ(365) and gₑ=0, it may mean that predictions at the end and beginning of year are the same. A prediction may be equal to or below a lowest observed daily temperature or a highest observed daily temperature and be equal to or above a lowest daily temperature or a highest daily temperature among lowest observed annual daily temperatures.

$${\vec{g}}_{i} = [ \begin{matrix}{f}_{x}^{( n )} ( 1 ) - {T}_{min}^{1} \\ ⋮ \\ {f}_{x}^{n} ( 365 ) - {T}_{min}^{365} \\ {T}_{x}^{min} - {f}_{x}^{n} ( 1 ) \\ ⋮ \\ {T}_{x}^{min} - {f}_{x}^{n} ( 365 )\end{matrix} ] \leq \vec{0} \qquad Equation 5$$

Next, the lowest ambient temperature profile information and highest ambient temperature profile information of each of the stations WS1 and WS2 may be configured as ambient temperature profile information and be stored in the memory 126 of the moving object 100, and a function coefficient parameter used for generating the ambient temperature profile information may also be stored in the memory 126.

As an example, a function coefficient parameter may be a polynomial coefficient cᵢ used for numerical optimization. Polynomial coefficients associated with lowest ambient temperature profile information may be c_{0,min}^{x},c_{1,min}^{x}, . . . c_{n-1,min}^{x}. Polynomial coefficients associated with highest ambient temperature profile information may be c_{0,max}^{x},c_{1,max}^{x}, . . . c_{n-1,max}^{x}.

The process of FIG. 5 for generating ambient temperature profile information may be performed in each of the stations WS1 and WS2, and the ambient temperature profile information and a function coefficient parameter may be transmitted to the moving object 100 and be managed at a request. As another example, the process of FIG. 5 may be performed when the processor 128 of the moving object 100 obtains surrounding station data from each station and calculates ambient temperature profile information.

Referring to FIG. 2A again, based on current position information of the moving object and surrounding station information of the plurality of stations WS1 and WS2, the processor 128 may not only calculate a lowest predicted temperature and a highest predicted temperature, which are expected at the position of the moving object, but also generate prediction profile information at S125.

Before calculating the lowest predicted temperature and the highest predicted temperature, the processor 128 may calculate an average virtual station altitude as shown in Equation 6 below.

$${\overline{h}}_{st} = ( \frac{{h}_{2} - {h}_{1}}{{ϕ}_{2} - {ϕ}_{1}} ) ( {ϕ}_{v e h} - {ϕ}_{1} ) + {h}_{1} \qquad Equation 6$$

Here, ϕ₁ and ϕ₂ may be latitudes of the first and second weather stations WS1 and WS2 respectively, and h₁ and h₂ may be altitudes above sea level for the first and second weather stations WS1 and WS2 respectively. ϕᵥₑₕ and hᵥₑₕ may be a latitude and an altitude above sea level respectively for the moving object 100.

Then, the processor 128 may calculate temperature correction ΔTₕ according to an altitude of the moving object 100 by using Equation 7. Equation 7 may be a correction equation according to an altitude of the moving object 100 above sea level.

$$Δ {T}_{h} ( {h}_{v e h} ) = \frac{0.5 C . °}{100 m} ( {\overline{h}}_{st} - {h}_{veh} ) \qquad Equation 7$$

Next, the processor 128 may calculate a lowest predicted temperature of the moving object 100 based on a lowest predicted ambient temperature and the temperature correction ΔTₕ according to lowest ambient temperature profile information of respective stations WS1 and WS2. For example, a lowest predicted temperature may be calculated by using Equation 8.

$${\hat{T}}_{min} ( d ) = ( \frac{{\hat{T}}_{min , 2} ( d ) - {\hat{T}}_{min , 1} ( d )}{{ϕ}_{2} - {ϕ}_{1}} ) ( {ϕ}_{v e h} - {ϕ}_{1} ) + {\hat{T}}_{min , 1} ( d ) + Δ {T}_{h} ( {h}_{v e h} ) \qquad Equation 8$$

Here, \hat{T}_{min,1}=f_{1,min}ⁿ(d) may be a lowest predicted ambient temperature of the first weather station WS1, \hat{T}_{min,2}=f_{2,min}ⁿ(d) may be a lowest predicted ambient temperature of the second weather station WS2, and d may be a date of a year with a shutdown request, being any one of 1 to 366.

Then, the processor 128 may calculate a highest predicted temperature of the moving object 100 based on a highest predicted ambient temperature and the temperature correction ΔTₕ according to highest ambient temperature profile information of respective stations WS1 and WS2. For example, a highest predicted temperature may be calculated by using Equation 9.

$${\hat{T}}_{max} ( d ) = ( \frac{{\hat{τ}}_{min , 2 ( d ) - {\hat{T}}_{min , 1} ( d )}}{{ϕ}_{2} - {ϕ}_{1}} ) ( {ϕ}_{v e h} - {ϕ}_{1} ) + {\hat{T}}_{max , 1} ( d ) + Δ {T}_{h} ( {h}_{v e h} ) \qquad Equation 9$$

Here, \hat{T}_{max,1}=f_{1,min}ⁿ(d) may be a highest predicted ambient temperature of the first weather station WS1, and \hat{T}_{max,2}=f_{2,max}ⁿ(d) may be a highest predicted ambient temperature of the second weather station WS2.

A lowest predicted temperature and a highest predicted temperature at a position of the moving object may be predicted by linear interpolation of multiple pieces of surrounding station information corresponding to a date when there is a shutdown request.

Prediction profile information may be generated according to each time section of a day based on a lowest predicted temperature and a highest predicted temperature. For example, prediction profile information may include daytime prediction profile information and nighttime prediction profile information according to each time section of a day.

Daytime prediction profile information may be generated based on a daylight hour estimated at a position of the moving object, a highest predicted temperature, and a lowest predicted temperature.

A daylight hour is a day-length at a date of a shutdown request, and a day-length b(d) may be calculated through, for example, Equation 10.

$$b ( d ) = \frac{arccos ( 1 - m ( d ) )}{180} \cdot 24 \qquad Equation 10$$

Here, a date of a shutdown request in a year may be any one of 1 to 366, and m(d) may be 1−tan(ϕᵥₑₕ)−tan(ψ·cos(j·(d+10))). ψ may be the obliquity of the ecliptic, and j may be a day of year to degree constant.

$$ψ = \frac{23.439}{180} and j = \frac{π}{182.625}$$

are exemplified in the present disclosure and may vary according to a position of the moving object.

When the time of solar noon is referred to as tₛₕ, the sunrise time may be calculated by

$${t}_{sr} = {t}_{s h} - \frac{b}{2}$$

and the sunset time may be calculated by

$${t}_{s s} = {t}_{s s} + \frac{b}{2} .$$

Herein, the culmination time tₛₕ of the sun may have a predetermined value according to each longitude and local time domain (e.g., Korean standard time). The moving object 100 may store a culmination time of each longitude in the memory 126 or recognize the culmination time by receiving it from outside.

For example, daytime prediction profile information may be temperature prediction profile of daytime according to sunrise and sunset and be referred to as a coldest day scenario of the moving object during daylight hours.

Specifically, daytime prediction profile information may be calculated based on a time of solar noon, a day-length, a highest predicted temperature, and a lowest predicted temperature.

For example, by using Equation 11, daytime prediction profile information may be determined by a temperature curve according to a coldest day scenario of a moving object during daylight hours.

$${\hat{T}}_{day} ( t ) = {\hat{T}}_{min} ( d ) - \frac{{T}_{k}}{2} + \frac{1}{2} \sqrt{{T}_{k}^{2} + 4 \cdot AMP \cdot {T}_{k} \cdot {S}_{1} ( t )} \qquad Equation 11$$

Here, Tₖ is a tuning constant (C),

$${S}_{1} ( t ) = sin ( π \cdot \frac{t - {t}_{sh} + \frac{b ( d )}{2}}{b ( d ) + 2 P} ) ,$$

and p may be a delay time (hr) from a culmination time tₛₕ of the sun to a highest daily temperature. Here, p is a climate feature of each region and may be stored as a different value according to each season. p may be stored in the memory 126 of the moving object 100 or be recognized as the moving object 100 receives it from outside. In addition, AMP may be calculated by

$$( {\hat{T}}_{max} ( d ) - {\hat{T}}_{min} ( d ) ) ( 1 + \frac{{\hat{T}}_{max} ( d ) - {\hat{T}}_{min} ( d )}{{T}_{k}} ) .$$

For example, nighttime prediction profile information may be temperature prediction profile of nighttime according to sunset and dawn and be referred to as a coldest day scenario of the moving object at a night time.

Specifically, nighttime prediction profile information may be calculated based on night hours estimated at a position of the moving object, a value of daytime prediction profile information \hat{T}_{day}(t) at a sunset time tₛₛ, that is, a predicted sunset temperature and a lowest predicted temperature. For example, by using Equation 12, nighttime prediction profile information may be determined by a temperature curve according to a coldest day scenario of a moving object during night hours.

$${\hat{T}}_{n ight} ( t ) = \frac{{\hat{T}}_{min} ( d ) - {\hat{T}}_{SS} \cdot {e}^{- \frac{η}{τ}} + ( {\hat{T}}_{SS} - {\hat{T}}_{min} ( d ) ) {e}^{- \frac{t - {t}_{S S}}{τ}}}{1 - {e}^{- \frac{η}{τ}}} \qquad Equation 12$$

Here, η refers to night hours, that is, a night length and may be calculated by 24−b(d)=tₛₛ−tₛᵣ. τ may be a temperature drop time constant (hr). In the present disclosure, it is exemplified as τ=4 but may vary according to a position of a moving object and a corresponding date.

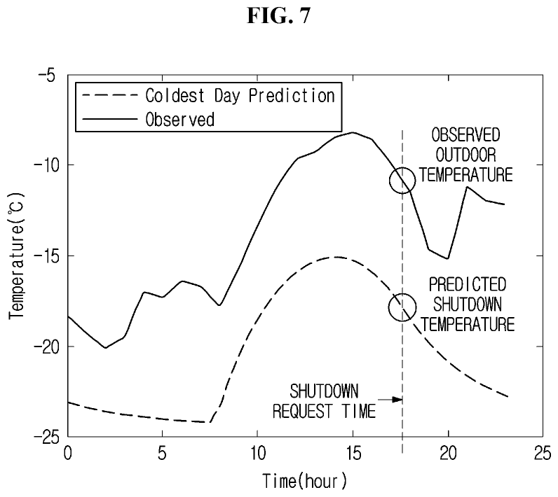

According to the above-described process, prediction profile information of the moving object 100 may be prepared to include not only a lowest predicted temperature and a highest predicted temperature but also, as exemplified in FIG. 7, daytime and nighttime prediction profile information. FIG. 7 is a view exemplifying line plots of prediction profile information that predicts temperatures at a position of a moving object.

Next, the processor 128 may check a time of a shutdown request, that is, whether or not a shutdown time belongs to the daytime at S130, and if the shutdown time belongs to the daytime, the processor 128 may determine to use daytime prediction profile information in prediction profile information at S135. If the time of the shutdown request belongs not to the daytime but to the nighttime, the processor 128 may determine to use daytime prediction profile information in prediction profile information at S140.

At step S130, the daytime may be determined as a time between a sunrise time tₛᵣ and a sunset time tₛₛ, and a lowest predicted temperature at a current position of the moving object 100 may be predicted by \hat{T}ₘᵢₙ=\hat{T}(tₛᵣ).

Referring to FIG. 2B, the processor 128 may check whether or not the outdoor temperature sensor 122 has normal operation at S145.

In case of normal operation, if an observed outdoor temperature T(t_{sd}) obtained from the outdoor temperature sensor 122 is equal to or above a predicted shutdown temperature \hat{T}(t_{sd}) (at N of S150), a lowest predicted temperature \hat{T}ₘᵢₙ of the moving object 100, which is predicted from prediction profile information, may be determined as a lowest estimated temperature \hat{T}ₘᵢₙ^{det} of the moving object 100 at S155.

The predicted shutdown temperature \hat{T}(t_{sd}) may be a temperature that is expected by prediction profile information corresponding to a shutdown time t_{sd}. For the prediction profile information, it is possible to use a temperature curve according to a coldest day scenario of a time section corresponding to the shutdown time t_{sd}, that is, one of daytime and nighttime prediction profile information. As exemplified in FIG. 7, when an observed outdoor temperature at a shutdown request time is higher than a predicted shutdown temperature, prediction profile information is valid in determining a lowest estimated temperature. In FIG. 7, the solid line represents an observed outdoor temperature, and the dotted line is a temperature curve according to prediction profile information.

Meanwhile, in case the outdoor temperature sensor 122 does not operate normally, the processor 128 may determine a lowest estimated temperature based on a predicted shutdown temperature and a lowest predicted temperature of prediction profile information by considering the possibility that an extremely cold situation can occur at a corresponding date. For example, a lowest predicted temperature \hat{T}ₘᵢₙ of the moving object 100, which is expected from profile information, may be determined as a lowest estimated temperature \hat{T}ₘᵢₙ^{det} of the moving object 100 at S155.

Unlike N of step S150, when an observed outdoor temperature is lower than a predicted shutdown temperature (at Y of S150), the processor 128 may determine a lowest estimated temperature \hat{T}ₘᵢₙ^{det} by a lowest predicted temperature of which the deviation is compensated by an observed outdoor temperature T(t_{sd}) and a predicted shutdown temperature \hat{T}(t_{sd}) at S160.

As an example, the lowest estimated temperature \hat{T}ₘᵢₙ^{det} according to step S160 may be determined by Equation 13.

$${\hat{T}}_{min}^{det} = {\hat{T}}_{min} - ( \hat{T} ( {t}_{s d} ) - T ( {t}_{s d} ) ) \qquad Equation 13$$

Next, the processor 128 may check a current amount of charge (SOC) of the battery 102 and check a predicted available output power of the battery 102 based on the amount of charge and a lowest estimated temperature at S170.

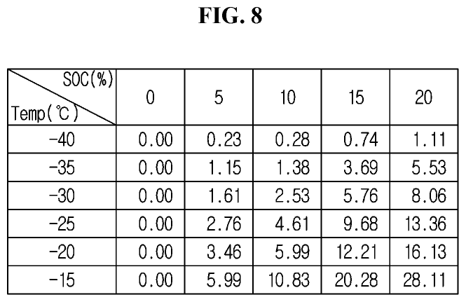

FIG. 8 is a view exemplifying a table that shows an available output of a battery according to temperatures and SOC of the battery. In the example of FIG. 8, when the battery 102 has 15% SOC and a lowest estimated temperature is −20 degrees, the battery 102 has an available output power of 12.21 kW. The processor 128 may identify the predicted available output power by referring to the table 8 of FIG. 8 stored in the memory 126.

Next, the processor 128 may check whether or not the predicted available output power of the battery 102 is equal to or smaller than a required output power at S175. As an example, the required output power may be a minimum output value that is necessary for startup of the moving object 100.

When the predicted available output power is equal to or smaller than the required output power for start-up, the processor 128 may be configured to determine a target amount of charge, which generates the required output power, and in order to enable the battery 102 reach the target amount of charge, generate power from the fuel cell 104 by keeping the moving object 100 running even at a shutdown request and charge the battery 102 with the generated power at S180.

If the predicted available output power of the lowest estimated temperature exceeds the required output power through charging by the fuel cell 104, the processor 128 may finish control for generating the fuel cell 104 and charging the battery 102 at S185. Next, the processor 128 may turn the moving object 100 off by performing a normal shutdown sequence according to a shutdown request at S190.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

1. A method for managing a battery of a moving object, the method comprising:
generating, in response to a shutdown request of the moving object, prediction profile information for predicting a future temperature at a position of the moving object, based on surrounding station information, which is based on a position of a weather station near the moving object, climate information, and current position information of the moving object;
determining a lowest estimated temperature at the position of the moving object based on an observed outdoor temperature at a time of the shutdown request, a predicted shutdown temperature at the time of the shutdown request, and a lowest predicted temperature of the prediction profile information, wherein the predicted shutdown temperature is based on the prediction profile information; and
charging a first battery by using a second battery so that a required output power for start-up is secured in response to a predicted available output power of the first battery being equal to or smaller than the required output power for start-up, wherein the predicted available output power of the first battery is based on the lowest estimated temperature and an amount of charge of the first battery of the moving object.

2. The method of claim 1, wherein the surrounding station information includes a surrounding latitude, a surrounding longitude according to the current position information and ambient temperature profile information based on the climate information, and
wherein the ambient temperature profile information includes lowest ambient temperature profile information, that is generated based on a lowest annual daily temperature, and highest ambient temperature profile information that is generated based on a highest annual daily temperature.

3. The method of claim 2, wherein the lowest ambient temperature profile information is generated as a lower bound approximation curve by applying numerical optimization using the lowest annual daily temperature, and the highest ambient temperature profile information is generated as a lower bound approximation curve by applying numerical optimization using the highest annual daily temperature; and
wherein the lowest ambient temperature profile information and the highest ambient temperature profile information further include a function coefficient parameter corresponding to an order defining constant, which is required in each numerical optimization, and the function coefficient parameter is stored in the moving object.

4. The method of claim 1, wherein the surrounding station information is obtained from a plurality of weather stations that are located in an order of proximity from the position of the moving object;
wherein the prediction profile information includes the lowest predicted temperature and a highest predicted temperature, which are generated based on the surrounding station information and the position information of the moving object; and
wherein the prediction profile information is generated according to each time section of a single day based on the lowest predicted temperature and the highest predicted temperature.

5. The method of claim 4, wherein the lowest predicted temperature and the highest predicted temperature are generated by applying temperature correction according to altitude information of the moving object, which is included in the position information.

6. The method of claim 4, wherein the prediction profile information includes daytime prediction profile information and nighttime prediction profile information according to each time section of the single day;
wherein the daytime prediction profile information is generated based on daylight hours estimated at the position of the moving object, the highest predicted temperature and the lowest predicted temperature; and
wherein the nighttime prediction profile information is generated based on night hours estimated at the position of the moving object, the lowest predicted temperature, and a sunset temperature that is predicted through the daytime prediction profile information.

7. The method of claim 6, wherein the predicted shutdown temperature is determined by using prediction profile information belonging to a shutdown time among the daytime prediction profile information and the nighttime prediction profile information.

8. The method of claim 1, further comprising determining a lowest estimated temperature at the position of the moving object based on the predicted shutdown temperature and the lowest predicted temperature of the prediction profile information, when the observed outdoor temperature is not obtained.

9. The method of claim 1, wherein determining the lowest estimated temperature comprises:
determining the lowest predicted temperature as the lowest estimated temperature, when the observed outdoor temperature is equal to or higher than the predicted shutdown temperature; and
determining the lowest predicted temperature as the lowest estimated temperature compensated for deviation though the observed outdoor temperature and the predicted shutdown temperature, when the observed outdoor temperature is lower than the predicted shutdown temperature.

10. The method of claim 1, wherein the second battery is configured as a fuel cell that is a different type from the first battery.

11. A device for managing a battery of a moving object, the device comprising:
a memory configured to store at least one instruction; and
a processor configured to execute the at least one instruction stored in the memory;
wherein the processor is configured to:
generate, in response to a shutdown request of the moving object, prediction profile information for predicting a future temperature at a position of the moving object, based on surrounding station information, which is based on a position of a weather station near the moving object, climate information, and a current position information of the moving object;
determine a lowest estimated temperature at the position of the moving object based on an observed outdoor temperature at a time of the shutdown request, a predicted shutdown temperature at the time of the shutdown request, and a lowest predicted temperature of the prediction profile information, wherein the predicted shutdown is based on the prediction profile information; and
charge a first battery by using a second battery so that a required output power for start-up is secured in response to a predicted available output power of the first battery being equal to or smaller than the required output power for start-up, wherein the predicted output power of the first battery is based on the lowest estimated temperature and an amount of charge of the first battery of the moving object.

12. The device of claim 11, wherein the surrounding station information includes a surrounding latitude, a surrounding longitude according to the current position information, and ambient temperature profile information based on the climate information, and
wherein the ambient temperature profile information includes lowest ambient temperature profile information, that is generated based on a lowest annual daily temperature, and highest ambient temperature profile information that is generated based on a highest annual daily temperature.

13. The device of claim 12, wherein the lowest ambient temperature profile information is generated as a lower bound approximation curve by applying numerical optimization using the lowest annual daily temperature, and the highest ambient temperature profile information is generated as a lower bound approximation curve by applying numerical optimization using the highest annual daily temperature, and
wherein the lowest ambient temperature profile information and the highest ambient temperature profile information further include a function coefficient parameter corresponding to an order defining constant, which is required in each numerical optimization, and the function coefficient parameter is stored in the moving object.

14. The device of claim 11, wherein the surrounding station information is obtained from a plurality of weather stations that are located in an order of proximity from the position of the moving object;
wherein the prediction profile information includes the lowest predicted temperature and a highest predicted temperature, which are generated based on the surrounding station information and the position information of the moving object; and
wherein the prediction profile information is generated according to each time section of a single day based on the lowest predicted temperature and the highest predicted temperature.

15. The device of claim 14, wherein the lowest predicted temperature and the highest predicted temperature are generated by applying temperature correction according to altitude information of the moving object, which is included in the position information.

16. The device of claim 14, wherein the prediction profile information includes daytime prediction profile information and nighttime prediction profile information according to each time section of the single day;
wherein the daytime prediction profile information is generated based on daylight hours estimated at the position of the moving object, the highest predicted temperature and the lowest predicted temperature; and
wherein the nighttime prediction profile information is generated based on night hours estimated at the position of the moving object, the lowest predicted temperature, and a sunset temperature that is predicted through the daytime prediction profile information.

17. The device of claim 16, wherein the predicted shutdown temperature is determined by using prediction profile information belonging to a shutdown time among the daytime prediction profile information and the nighttime prediction profile information.

18. The device of claim 11, wherein the processor is further configured to determine a lowest estimated temperature at the position of the moving object based on the predicted shutdown temperature and the lowest predicted temperature of the prediction profile information, when the observed outdoor temperature is not obtained.

19. The device of claim 11, wherein determining the lowest estimated temperature comprises:
determining the lowest predicted temperature as the lowest estimated temperature, when the observed outdoor temperature is equal to or higher than the predicted shutdown temperature; and
determining the lowest predicted temperature as the lowest estimated temperature compensated for deviation though the observed outdoor temperature and the predicted shutdown temperature, when the observed outdoor temperature is lower than the predicted shutdown temperature.

20. The device of claim 11, wherein the second battery is configured as a fuel cell that is a different type from the first battery.
